(19) United States
(12) Patent Application Publication
(10) Pub. No.: US 2005/0126589 A1
(43) Pub. Date: Jun. 16, 2005

(54) Cleaning device of slit nozzle for coating and coating apparatus

(76) Inventors: Shigenari Horie, Hiroshima-ken (JP); Masahiro Sugihara, Hiroshima-ken (JP); Kenji Yamada, Hiroshima-ken (JP); Chizuka Yamada, Hiroshima-ken (JP); Hiroshi Miura, Hiroshima-ken (JP); Toshiaki Miyakura, Hiroshima-ken (JP)

Correspondence Address: WENDEROTH, LIND & PONACK, L.L.P., 2033 K STREET N. W., SUITE 800, WASHINGTON, DC, 20006-1021, US

(21) Appl. No.: 10/875,771

(22) Filed: Jun. 25, 2004

(30) Foreign Application Priority Data
Jun. 25, 2003 (JP) 2003-180900

(51) Int. Cl. B05C 11/00

(52) U.S. Cl. 134/6; 15/246; 118/302; 239/123

(57) ABSTRACT

The present invention intends to provide a cleaning device of a slit nozzle for use in a coating device which makes it possible to carry out a cleaning operation efficiently without human labor and suppress lowering of productivity due to the cleaning work. The present invention also intends to provide a coating device having effects and advantages similar to those of the cleaning device. According to the present invention, in order to attain the above purpose, there is provided a cleaning device for the tip end 2c of the slit nozzle 2, and the cleaning device including a wiping member 3 for wiping the tip end 2c and a first moving mechanism 5 for moving the wiping member 3 in the width direction of the coating web 1 in a reciprocal manner.

### BACKGROUND OF THE INVENTION

1. Field of the Invention

The present invention relates to (1) a cleaning device of a slit nozzle for use in a coating apparatus in which a coating liquid flow is formed between a slit nozzle and a conveyed coating web and the coating web is coated with the coating liquid flow and (2) the coating apparatus employing the cleaning device.

2) Description of the Related Art

Many kinds of printing paper sheets such as a photograph printing paper, a magnetic recording paper, a thermosensitive recording paper, a pressure sensitive recording paper, an ink-jet recording paper, thermal-transfer type recording paper and a pigment coating paper are fabricated by coating a predetermined coating liquid on a raw material paper (web). FIG. 5 is a diagram showing one example of a slit nozzle for performing the above-described coating process.

The slit nozzle 2 has a cross-sectional shape as shown in FIG. 5. A coating liquid flow 13 extending over the whole width of a web (material to be coated) 1 can be created from the slit nozzle 2 toward the web 1 conveyed under the slit nozzle 2. The slit nozzle 2 has in its internal space a manifold 2a formed over substantially the whole width of the slit nozzle 2 and a gap (hereinafter referred to as nozzle gap or gap) 2b having a slit shape of about 1 mm, for example. The gap 2b communicates with the manifold 2a at the upper end thereof and reaches a slit tip end 2c at the lower end thereof, whereby the lower end of gap 2b forms a spout feeding a coating liquid flow 13 toward the web 1. The coating liquid 13 is supplied to the manifold 2a with pressure from a coating liquid reserving tank by a pressure pump (the reserving tank and the pressure pump are not shown). The pressurized coating liquid 13 passes through the gap 2b and flows down from the tip end 2c of the nozzle by forming a curtain-like thin liquid film (hereinafter sometimes referred to as a curtain film) toward the web 1. The coating liquid flow 13 applied on the web 1 forms a coating liquid film 9 on the web 1.

The web 1 coated with the coating liquid film 9 formed thereon is conveyed to a drier not shown, in which the coating liquid film 9 is dried by the drier and the coating process is completed.

In the above-described coating process, an important production quality is to form the coating liquid film on the web 1 with a uniform thickness, so various kinds of technologies have been proposed to achieve this end.

For example, Japanese Patent Application Publication No. 2001-246300 discloses a technology for avoiding rupture in the curtain film by a contraction of coating liquid flow from the slit nozzle, a flexible neck-in preventing member is drooped at the both end sides of the slit nozzle.

U.S. Pat. No. 6,524,388 is incorporated by reference. U.S. Pat. No. 6,524,388 discloses a technology in which an air chamber and air jetting means are provided on the upstream side of the web conveying direction with respect to the slit nozzle. When the web is conveyed, the web is accompanied by an air flow which is brought about around the web (this air flow refers to an entrainment air). According to the above technology, the air jetting means is controlled to adjust the amount of jetted air so that the fluctuation in the entrainment air amount, which is caused by the fluctuation in the web conveying speed can be absorbed. Further, the air chamber pressure is controlled to be within a predetermined range so that the condition around the slit nozzle is kept optimum. In this way, even minute bubbles can be prevented from being left between the coating liquid film and the web surface, with the result that the coating liquid film can be free from defects.

However, the above-described technologies intend to solve problems concerning the fluctuation in the coating liquid contraction flow, the entrained air and so on which can cause uneven coating liquid film formation on the web (uniform liquid film prohibiting factor). Other uniform liquid film prohibiting factors may be itemized as follows. That is, foreign substances such as a coagulate of coating liquid and minute dust particles can be attached to the tip end of the slit nozzle.

If a foreign substance is attached to the tip end of the slit nozzle, then the coating liquid downward flow from the nozzle could be hindered. As a result, the curtain film comes to have an unevenness having a line shape (i.e., the curtain film comes to have an uneven thickness in the device width direction). Furthermore, the curtain film can suffer from rupture, with the result that the coating liquid film formed on the web can fail to have a uniform thickness.

In addition to foreign substances attached to the slit nozzle, other possible causes shall be taken into account, along with countermeasures requested against such a possible cause. For example, when the degree of wetting is uneven on the slit nozzle tip end in the device width direction, if the coating liquid spouting is started, the curtain film comes to have the aforesaid unevenness having a line shape due to the uneven wetting.

Once a foreign substance is attached to the slit nozzle tip end, it is often difficult to remove by the downward flow of the coating liquid from the slit nozzle. Therefore, under the present conditions, the cleaning work for the slit nozzle tip end is carried out by hand. In this case, cleaning will be performed near the slit nozzle. Thus, it is necessary to stop the web conveying, i.e., to completely halt the production line for safety. Moreover, manual cleaning is time-consuming, with the result that the efficiency of the production line will be remarkably lowered.

### SUMMARY OF THE INVENTION

The present invention is made in view of the above and therefore it is an object of the present invention to provide a slit nozzle cleaning device for use in a coating apparatus and a coating apparatus employing such a cleaning device in which cleaning work can be efficiently performed without human labor, thereby preventing lowering of production line efficiency.

According to the present invention, in order to attain the above object, there is provided a cleaning device of a slit nozzle for use in a coating apparatus provided on the slit nozzle for cleaning the tip end thereof, the slit nozzle being disposed above a conveyed coating web (material to be coated), having a spout at the tip end elongated in the width direction of the coating web, and spouting a coating liquid toward the coating web, the cleaning device of the slit nozzle for use in a coating apparatus characterized by including a wiping member for wiping the tip end, and a first moving mechanism for moving the wiping member in the width direction of the coating web in a reciprocal manner.

According to the above arrangement, the wiping member contacting with the trip end of the slit nozzle can be moved in the width direction of the material to be coated by the first moving mechanism, and owing to this wiping action, a foreign substance attached to the tip end can be wiped off. Therefore, cleaning can be effectively performed without human labor, and moreover productivity lowering can be suppressed by such cleaning work.

The cleaning device of a slit nozzle for use in a coating apparatus may be preferably arranged in such a manner that, when the cleaning operation is not activated, the first moving mechanism places the wiping member in a predetermined sheltering position in the width direction away from the coating liquid flow from the spout toward the coating web.

The cleaning device of a slit nozzle for use in a coating apparatus according to the present invention may preferably have an arrangement which further includes a second mechanism moving the wiping member in the conveying direction of the coating web between a position where the wiping member contacts the tip end of the slit nozzle and a predetermined sheltering position in the conveying direction where the wiping member is kept away from the coating liquid flow.

The second moving mechanism may be, for example, arranged to achieve the selective position taking by rotating the wiping member around the axis extending in the width direction of the coating web, whereby the wiping member is moved in the conveying direction of the coating web.

The cleaning device of a slit nozzle for use in a coating apparatus according to the present invention may be preferably arranged to include a wiping member washing device for washing the wiping member in the predetermined sheltering position where the wiping member is kept away from the coating liquid flow in the width direction.

The cleaning device of a slit nozzle for use in a coating apparatus according to the present invention may preferably have an arrangement such that the wiping member washing device includes a wiping member washing liquid spouting device for spouting a wiping member washing liquid toward the wiping member and a washing liquid recovering device for recovering the wiping member washing liquid which is used for washing the wiping member.

The cleaning device of a slit nozzle for use in a coating apparatus according to the present invention may be preferably arranged to include a nozzle washing liquid spouting device for spouting a nozzle washing liquid toward the tip end of the slit nozzle before the wiping member wipes the tip end of the slit nozzle.

The present invention further intends to provide a coating apparatus for coating a web (material to be coated) conveyed in a predetermined direction with a coating liquid flow which is spouted from a spout of a slit nozzle disposed above the conveyed web, the spout being elongated in the width direction of the coating web, the coating apparatus arranged to include a cleaning device based on any one of those described above.

### BRIEF DESCRIPTION OF THE DRAWINGS

FIG. 1 is a schematic cross-sectional side view showing an arrangement of a cleaning device of a slit nozzle for use in a coating apparatus and an apparatus itself as one embodiment of the present invention;

FIG. 2 is a schematic frontal view showing an arrangement of the cleaning device of the slit nozzle for use in the coating apparatus and the apparatus itself as one embodiment of the present invention;

FIG. 3 is a schematic cross-sectional side view showing an arrangement of the cleaning device of the slit nozzle for use in the coating apparatus and the apparatus itself as one embodiment of the present invention;

FIG. 4 is a schematic cross-sectional side view showing an arrangement of a cleaning pad washing device as one embodiment of the present invention; and

FIG. 5 is a schematic cross-sectional side view showing an arrangement of a slit nozzle for use in a coating apparatus.

### DESCRIPTION OF THE PREFERRED EMBODIMENTS

An embodiment of the present invention will be hereinafter described with reference to drawings.

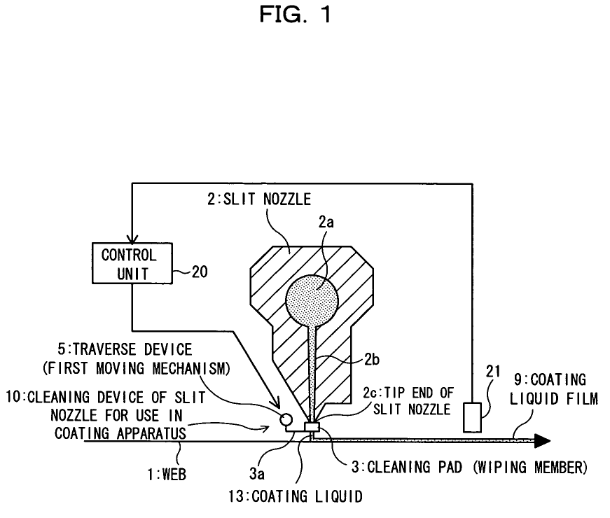

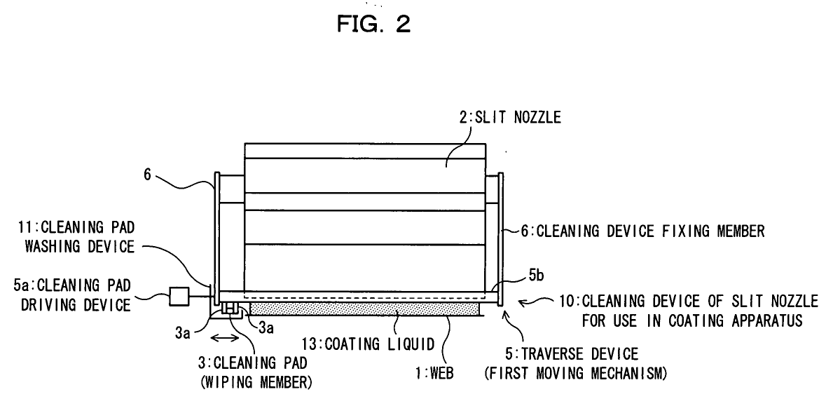

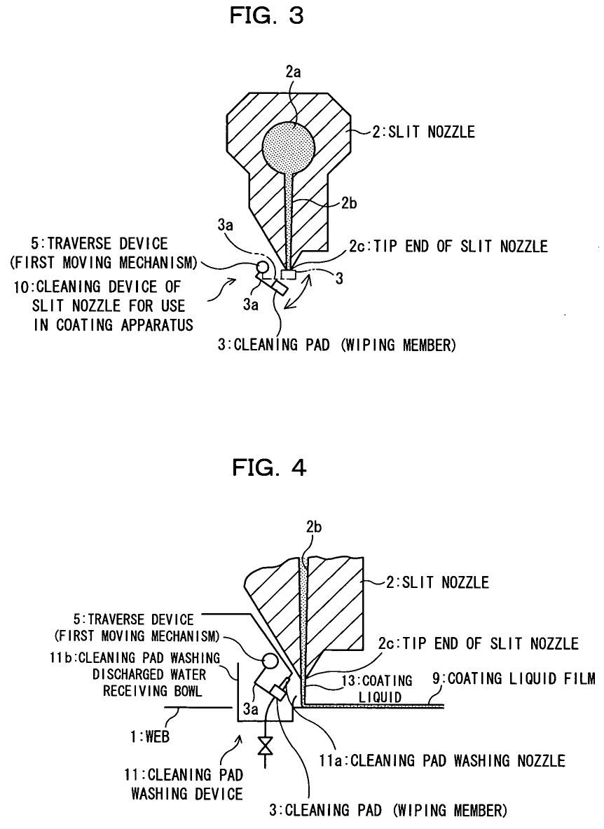

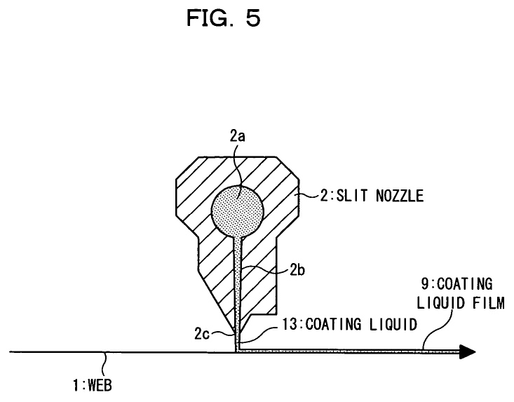

FIGS. 1 to 4 are diagrams each showing a cleaning device of a slit nozzle for use in a coating apparatus and the coating apparatus itself as one embodiment of the present invention. FIG. 1 is a schematic cross-sectional side view showing an arrangement thereof, FIG. 2 is a schematic frontal view showing the arrangement thereof (diagram as viewed from the web conveying direction), FIG. 3 is a schematic cross-sectional side view showing an arrangement thereof to which reference is made for illustrating a cleaning pad placed in a rotational sheltering position, and FIG. 4 is a schematic cross-sectional side view showing an arrangement of a cleaning pad washing device. In the above figures, components corresponding to those described in the prior art description have the same reference numerals and will not be described.

As shown in FIG. 1, the coating apparatus as one embodiment of the present invention includes a slit nozzle 2, a cleaning device 10 for cleaning the slit nozzle 2, a control unit 20 for controlling various operations of the coating apparatus, and a uniform film formation sensor (detecting unit) 21 (the control unit 20 and the uniform film formation sensor 21 are illustrated only in FIG. 1).

The uniform film formation sensor 21 is a unit for detecting whether or not a coating liquid film 9 on the web (material to be coated) 1 has a uniform thickness in the web width direction (This direction is a perpendicular direction relative to the paper sheet face of FIG. 1. This direction hereinafter is sometimes referred to as device width direction). Detection information generated from the uniform film formation sensor 9 is supplied to the control unit 20. When the control unit 20 is supplied with a signal indicating that the coating liquid film 9 has uneven thickness from the uniform film formation sensor 21, then the control unit 20 determines that there is a danger that a foreign substance is attached to the tip end 2c of the nozzles 2. Then, the control unit 20 stops the operation of a pump (not shown) sending the coating liquid to the slit nozzle 2 under pressure, halts the downward coating liquid flow from the slit nozzle 2, and thereafter issues a command to the cleaning device to start cleaning operation. Thus, the cleaning device 10 performs cleaning operation on the tip end 2c of the nozzle 2.

The above-described uniform film formation sensor may be replaced with a curtain film sensor which can detect whether or not the curtain film downward flow toward the web 1 has a uniform thickness in the device width direction. That is, an arrangement may be made such that if the curtain film sensor detects that the curtain film has an uneven thickness, the cleaning operation is activated.

More specifically, the detecting unit for detecting whether or not the coating liquid film 9 has a uniform thickness in the web width direction may not be limited to one detecting the uniformity of the coating liquid film thickness directly, but an other type of detecting unit maybe employed such as one detecting a factor, e.g., the curtain film thickness evenness which is relevant to the evenness of the coating liquid film thickness.

As shown in FIGS. 1 and 2, the cleaning device 10 of the present embodiment is arranged to include a cleaning pad (wiping member) 3 and a traverse device (first moving mechanism) 5 for moving the cleaning pad 3 in the width direction of the web 1.

The cleaning pad 3 is set to have a dimension regarding the web width direction smaller than the nozzle tip end 2c and a dimension regarding the web conveying direction larger than the nozzle tip end 2c. Further, the cleaning pad 3 is coupled to the traverse device 5 by means of L-letter shaped arms 3a, 3a. In this state, the traverse device 5 is activated so that the cleaning pad 3 is moved in the device width direction (web width direction) under the condition that the cleaning pad 3 is contacted to the tip end 2c of the slit nozzle 2. Thus, a foreign substance attached to the tip end 2c of the slit nozzle 2 will be wiped off over the whole width of the slit nozzle 2. The cleaning pad 3 may be formed of a material having a resilient nature such as rubber.

As shown in FIG. 2, the traverse device 5 is arranged to include a cleaning pad driving device 5a and a casing 5b elongated in the device width direction. The driving device 5a is a motor capable of revolving in a forward and backward directions. The casing 5b is fixed to and supported by cleaning device fixing members 6 attached to both the side end faces of the slit nozzle 2. The casing 5b accommodates therein a screw shaft rotatably supported by the aforesaid fixing members 6. The motor 5a is utilized for rotationally driving the screw shaft. The screw shaft has a nut meshed therewith. The aforesaid arm 3a having the cleaning pad 3 attached thereto is mounted through the nut in the casing 5b so as to be movable in the device width direction (i.e., the casing 5b has a function as a rail which guides the movement of the arm 3a in the device width direction).

With this arrangement, if the motor 5a rotationally drives the screw shaft, the nut, the arm 3c and the cleaning pad 3 can be collectively moved along the screw shaft in the device width direction. Further, as described above, the motor 5a can rotate in the forward and backward direction. Therefore, the cleaning pad 3 can move along the screw shaft in a reciprocal manner.

As shown in FIG. 2, the casing 5b (and the screw shaft) is set to have a length longer in the width direction than the slit nozzle 2 and the web 1 so that a certain margin (sheltering position) can be secured at both the ends of the slit nozzle 2 and the web 1. When the mode of the coating apparatus is an ordinary coating operation mode, in order not to hinder the downward flow of coating liquid from the nozzle tip end 2c, the cleaning device is placed in a sheltering position in the width direction away from the slit nozzle 2 in the device width direction.

At the sheltering position in the width direction, there is provided a cleaning pad washing device (wiping member washing device) 11 for washing the cleaning pad 3 which has undergone the cleaning operation. As shown in FIG. 4, the cleaning pad washing device 11 is arranged to include a cleaning pad washing nozzle (wiping member washing liquid jetting device) 11a and washing discharged water receiving bowl (washing liquid recovering device) 11b. The cleaning pad washing nozzle 11a is a device for jetting cleaning pad washing liquid (e.g., water) toward the cleaning pad 3. The discharged washing water receiving bowl 11b is one for recovering the washing liquid (washing discharged water) which has been used for washing the cleaning pad 3.

Between the aforesaid fixing members 6, 6 and the traverse device 5, there is interposed a rotation moving mechanism not shown. The rotation moving mechanism rotationally moves the traverse device 5 together with the cleaning pad 3 around the casing 5b so that the cleaning pad 3 can move between a rotational contact position (position indicated by a double-dash chain line in FIG. 3) where the cleaning pad 3 contacts the nozzle tip end 2c and a sheltering position in the rotational direction (position indicated by a solid line in FIG. 3) where the cleaning pad 3 is kept away from the slit nozzle 2 in the web conveying direction, i.e., where the cleaning pad 3 does not hinder the coating liquid flow from the nozzle tip end 2c. It follows that the rotational moving mechanism can function as a web conveying direction moving mechanism (second moving mechanism) which moves the cleaning pad 3 between the position where the cleaning pad contacts the slit nozzle 2 and the position where the cleaning pad 3 is kept away from the slit nozzle 2 in the web conveying direction, i.e., where the cleaning pad 3 does not hinder the coating liquid flow from the nozzle tip end 2c.

The cleaning device of the slit nozzle for use in the coating apparatus and the coating apparatus employing the cleaning device as the embodiment of the present invention are constructed as described above. The cleaning operation of the nozzle tip end is performed as described below (a method of cleaning the slit nozzle for use in the coating apparatus as one embodiment of the present invention).

That is, if the uniform film formation sensor 21 detects that the thickness of the coating liquid film 9 is uneven, the control unit 20 stops downward flow of coating liquid from the slit nozzle 2 (at this time the web 1 continues to be conveyed) and outputs a command of activation to the motor 5a to activate the traverse device 5. In response to the activation of the traverse device 5, the cleaning pad 3, which is placed in the sheltering position in the width direction as shown in FIG. 2 and also placed in the contact rotational position capable of contacting the nozzle tip end 2c, is moved to the right end in FIG. 2. In this way, the cleaning pad 3 can remove a foreign substance attached to the nozzle tip end 2c. Further, degree of wetting on the nozzle tip end 2c will become unvarying. Therefore, it is expected that the thickness of the curtain film 13 will be uniform in the width direction of the device and hence the thickness of the coating liquid film 9 on the web 1 will be uniform.

According to a prior art technology, when the cleaning operation is performed on the nozzle tip end 2c, in addition to the stopping of the downward flow of coating liquid from the slit nozzle 2, conveying of web 1 is also stopped in order to secure a safe work environment for a worker who manually accesses the device for cleaning. Conversely, according to the arrangement of the present embodiment, cleaning is performed by the cleaning device 10. Therefore, the conveyance of web 1 is continued even when cleaning is performed. As a result, it is expected to obviate a time period in which the conveying of the web 1 is once stopped and resumed to raise the web conveying speed to a predetermined ordinary driving speed if the cleaning operation is performed by hand. Accordingly, the time period requested to recover the ordinary driving mode can be shortened and the lowering in the productivity of the cleaning work due to the cleaning work can be suppressed.

Thereafter, the control unit 20 activates the rotational moving device to place the cleaning pad 3 in the sheltering rotational position and resumes the downward flow of coating liquid from the slit nozzle 2. As described above, when the cleaning work with the cleaning pad 3 is completed, the cleaning pad 3 is immediately placed in the sheltering rotational position by the rotational moving device. Therefore, the coating liquid downward flow can be started without waiting for the returning of the cleaning pad 3 to the sheltering position in the width direction which is shown in the left end of the coating device shown in FIG. 2.

Subsequently, the control unit 20 moves the cleaning pad 3, which is placed in the sheltering rotational position, to the sheltering position in the width direction. Then, the washing liquid jetting device 11a jets the washing liquid to the cleaning pad 3 to cleanse the cleaning pad 3. In this way, the cleaning pad 3 having been washed and kept in a cleaned state is prepared so that the next cleaning operation for the nozzle tip end 2c will be effectively performed. Then, the cleaning pad is kept in the sheltering position in the width direction until the next cleaning.

The present invention is not limited to the above-described embodiments but various changes and modifications could be effected without departing from the gist of the present invention.

For example, while in the above embodiments description has been made on an arrangement having the rotational moving device provided therein, the arrangement without the rotational moving device is possible. In this case, when the curtain film downward flow is resumed, the cleaning device is moved to the sheltering position in the width direction by the traverse device (first moving mechanism) 5 in advance.

Further, as shown with a two-dot chain line in FIG. 3, the cleaning device of the present invention may have a washing liquid jetting nozzle (nozzle washing liquid jetting device) 7. The washing liquid jetting nozzle 7 may be activated to jet the nozzle washing liquid to the slit nozzle tip end 2c for washing. With this arrangement, it becomes possible to perform more effectively the wiping action for removing a solid foreign substance attached to the slit nozzle tip end 2c by the cleaning pad 3. The following is a concrete arrangement employing the washing liquid jetting nozzle 7. That is, the washing liquid jetting nozzle 7 is moved synchronistically with the motion of the cleaning pad 3 and the traversal motion of the washing liquid jetting nozzle 7 is arranged to be slightly ahead of the cleaning pad 3. In this arrangement, a single washing liquid jetting nozzle 7 is moved in the device width direction by a device similar to the aforesaid traverse device 5 while the washing liquid jetting nozzle 7 jets the washing liquid. Alternatively, other possible arrangement is as follows. That is, a plurality of washing liquid jetting devices 7 are fixedly arrayed in the device width direction with an interval interposed therebetween (e.g., the plurality of washing liquid jetting devices 7 may be fixed to the slit nozzle 2).

The cleaning pad can wipe off dirt on the slit lip tip end (slit tip end) 2c. However, a lump of the coating liquid or fine dust particles will accumulate not only on the nozzle lip tip end 2c but also in a gap within the inner space of the nozzle lip (on the tip end side of the nozzle gap 2b). These lumps and particles will hinder uniform coating. In order to wipe off the accumulated substances within the nozzle lip inner space, as shown by the two-dot chain line in FIG. 3, a scraper 8 having a thickness smaller than the nozzle gap may be provided so that the scraper 8 can move back and forth in relation to the cleaning pad 3 (FIG. 3 shows a state in which the scraper 8 is extended). In this arrangement, when the aforesaid cleaning pad 3 is placed in the rotational contact position by the rotational moving mechanism, the scraper 8 is extended from the cleaning pad 3 so that the scraper 8 is inserted into the nozzle gap 2b. Thereafter, the scraper 8 is reciprocated along the device wide direction together with the cleaning pad 3 by the traverse device 5. Thus, the wiping operation for the inner space of the nozzle gap 2b can be performed.

In the above embodiments, when the cleaning operation is performed on the slit nozzle tip end 2c, the downward flow of the coating liquid 13 from the slit nozzle 2c is interrupted.

That is, in the above embodiments, if the uniform film formation sensor 21 detects unevenness of the thickness of the coating liquid film 9, then the downward flow of the coating liquid 13 toward the web 1 is interrupted, the cleaning pad 3 is brought to the slit nozzle 2, the cleaning pad 3 is moved in a reciprocal manner, the cleaning pad 3 is moved back to the sheltering position in the width direction, and thereafter the downward flow of the coating liquid 13 is resumed.

Conversely, the arrangement of the present invention may be modified in such a manner that the downward flow of the coating liquid 13 is not interrupted upon performing the cleaning action. In this case, the cleaning operation can be performed while the uniform film formation sensor 21 examines whether or not the thickness of the coating liquid film 9 is uniform. That is, the downward flow of the coating liquid 13 toward the web 1 is fundamentally always placed in the driving mode, and during a time period in which the uniform film formation sensor 21 detects the unevenness of the thickness of the coating liquid film 9, the cleaning pad 3 is activated into the cleaning action performing mode. Then, the cleaning pad 3 is driven in the cleaning operation performing mode until the coating liquid film 9 restores the uniform thickness thereof.

1. A cleaning device of a slit nozzle for use in a coating apparatus comprising:
a wiping member for wiping a tip end of the slit nozzle which has a spout elongated in the width direction of a conveyed coating web and spouting a coating liquid flow toward the coating web; and
a first moving mechanism for moving the wiping member in the width direction of the coating web in a reciprocal manner.

2. A cleaning device of a slit nozzle for use in a coating apparatus according to claim 1, wherein
when the cleaning operation is not activated, the first moving mechanism places the wiping member in a predetermined sheltering position in the width direction where the wiping member is kept away from the spouted coating liquid flow.

3. A cleaning device of a slit nozzle for use in a coating apparatus according to claim 2, further comprising:
a second mechanism which moves the wiping member in the conveying direction of the coating web between a position where the wiping member contacts the tip end of the slit nozzle and a predetermined sheltering position where the wiping member is kept away from the coating liquid flow.

4. A cleaning device of a slit nozzle for use in a coating apparatus according to claim 3, wherein
the second moving mechanism achieves movement of the wiping member in the conveying direction of the coating web by rotating the wiping member around the axis extending in the width direction of the coating web.

5. A cleaning device of a slit nozzle for use in a coating apparatus according to claim 2, comprising a wiping member washing device for washing the wiping member in the predetermined sheltering position where the wiping member is kept away from the coating liquid flow in the width direction.

6. A cleaning device of a slit nozzle for use in a coating apparatus according to claim 5, wherein the wiping member washing device includes a wiping member washing liquid spouting device for spouting a wiping member washing liquid toward the wiping member and a washing liquid recovering device for recovering the wiping member washing liquid which is used for washing the wiping member.

7. A cleaning device of a slit nozzle for use in a coating apparatus according to claim 1, comprising a nozzle washing liquid spouting device for spouting a nozzle washing liquid toward the tip end of the slit nozzle before the wiping member wipes the tip end of the slit nozzle.

8. A cleaning device of a slit nozzle for use in a coating apparatus according to claim 2, comprising a nozzle washing liquid spouting device for spouting a nozzle washing liquid toward the tip end of the slit nozzle before the wiping member wipes the tip end of the slit nozzle.

9. A cleaning device of a slit nozzle for use in a coating apparatus according to claim 5, comprising a nozzle washing liquid spouting device for spouting a nozzle washing liquid toward the tip end of the slit nozzle before the wiping member wipes the tip end of the slit nozzle.

10. A cleaning device of a slit nozzle for use in a coating device comprising:
a wiping member for wiping a tip end of the slit nozzle which has a spout elongated in the width direction of a conveyed coating web and spouts a coating liquid flow toward the coating web;
a first moving mechanism for moving the wiping member in the width direction of the coating web in a reciprocal manner;
a control unit for controlling the operation of the first moving mechanism; and
a detecting device for detecting whether the coating liquid forms a coating film having a uniform thickness on the coating web or not, wherein
if the detecting device detects that the coating liquid does not form a coating film having a uniform thickness on the coating web,
then the control unit activates the first moving mechanism to move the wiping member so that the wiping member performs the wiping action.

11. A cleaning device of a slit nozzle for use in a coating apparatus according to claim 10, wherein
when the cleaning operation is not activated, the first moving mechanism places the wiping member in a predetermined sheltering position in the width direction where the wiping member is kept away from the spouted coating liquid flow.

12. A cleaning device of a slit nozzle for use in a coating apparatus according to claim 11, comprising a wiping member washing device for washing the wiping member in the predetermined sheltering position in the width direction.

13. A cleaning device of a slit nozzle for use in a coating apparatus according to claim 10, comprising a nozzle washing liquid spouting device for spouting a nozzle washing liquid toward the tip end of the slit nozzle before the wiping member wipes the tip end of the slit nozzle.

14. A coating apparatus comprising:
a slit nozzle disposed above a conveyed coating web, having a spout elongated in the width direction of the coating web, and spouting a coating liquid from the spout toward the coating web; and
the cleaning device according to claim 1.

15. A coating apparatus comprising:
a slit nozzle disposed above a conveyed coating web, having a spout elongated in the width direction of the coating web, and spouting a coating liquid from the spout toward the coating web; and
the cleaning device according to claim 2.

16. A coating apparatus comprising:
a slit nozzle disposed above a conveyed coating web, having a spout elongated in the width direction of the coating web, and spouting a coating liquid from the spout toward the coating web; and
the cleaning device according to claim 5.

17. A coating apparatus comprising:
a slit nozzle disposed above a conveyed coating web, having a spout elongated in the width direction of the coating web, and spouting a coating liquid from the spout toward the coating web; and
the cleaning device according to claim 7.

18. A method of cleaning a slit nozzle for use in a coating apparatus comprising steps of:
activating a moving mechanism to move a wiping member so as to wipe a tip end of the slit nozzle having a spout which spouts a coating liquid flow toward a coating web; and
activating the moving mechanism to move the wiping member to a sheltering position where the wiping member does not interfere with the coating liquid flow.

19. A method of cleaning a slit nozzle for use in a coating apparatus according to claim 18, further comprising a step of:
washing the wiping member in the predetermined sheltering position.

20. A method of cleaning a slit nozzle for use in a coating apparatus according to claim 18, further comprising a step of:
spouting a washing liquid toward the tip end of the slit nozzle before the wiping action is performed.
